(19) United States
(12) Patent Application Publication
(10) Pub. No.: US 2025/0072455 A1
(43) Pub. Date: Mar. 6, 2025

(54) FRUIT PEEL WASTES-BASED COMPOSITE AND A PROCESS FOR ITS PREPARATION THEREOF

(71) Applicant: COUNCIL OF SCIENTIFIC AND INDUSTRIAL RESEARCH AN INDIAN REGISTERED BODY INCORPORATED, New Delhi (IN)

(72) Inventors: Natarajan Velmuragan, Jorhat (IN); Diganta Kumar Saikia, Jorhat (IN); Channkeshavaiah Chikkaputtaiah, Jorhat (IN)

(21) Appl. No.: 18/504,260

(22) Filed: Nov. 8, 2023

(30) Foreign Application Priority Data
Sep. 1, 2023 (IN) 202311058900

(51) Int. Cl. A23K 10/37; A23K 50/80

(52) U.S. Cl. CPC A23K 10/37; A23K 50/80

(57) ABSTRACT

The invention discloses creation of a composite consists of different fruit peels followed by enrichment with omega-3 fatty acids originally derived from microorganisms of group Thraustochytrids. The process comprises the following steps: 1) collecting fresh waste of pineapple peels, banana peels, orange peels and mausambi peels, drying, removing rotten parts and grinding them to powder; 2) synergization of best combination for the creation of fruit peel wastes-based composite using response surface methodology; 3) inoculation of Aurantiochytrium cells in to the composite of fruit peel wastes and incubation at 25° C. thereby obtaining enriched composite comprising microbially-derived omega-3 fatty acids and fruit peel wastes in Solid State Fermentation conditions; 4) total protein content of the composite adjusted to at least about 30% or 40% with soyabean husk or soyabean. The final product can be processed as feed supplement to fish to enhance the fatty acids content of fishes. This invention finds suitability over prior art because the present invention is an eco-friendly, zero-waste, low cost, facile, rapid and solid waste management system.

### FIELD OF THE INVENTION

The present invention relates to a fruit peel wastes-based composite as a feed product for aquaculture farms and industries. The invention provides a composite consisting of different fruit peels, followed by nutritional enrichment of the same composite using omega-3 fatty acids of thraustochytrids. Nutritionally enriched material can be directly used as feed for aquaculture industries. In particular, the invention predominantly utilizes discarded fruit peel wastes especially pineapple, banana, orange and mausambi peels for a creation of composite using response surface methodology. The composite can be used as base material for creation of aquaculture feed.

### BACKGROUND OF THE INVENTION

Global fish production stands at 167 million tons, of which 44% (73.8 million tons) is contributed by the aquaculture sector. Much of the future demand of fish can be fulfilled by aquaculture as 70% of the resources of global capture fishery was already exploited. For billions of people worldwide, fish is the primary source of animal protein. Contributing to 6.3% of the total global fish production, India ranks second in aquaculture and third in fisheries. In India, 5.4% of agricultural GDP and 1.4% of national gross domestic product (GDP) were contributed by these industries which adds nearly INR 200 trillion to the national economy. In India, the top producers of freshwater fish through aquaculture are from the States of Andhra Pradesh, West Bengal, Bihar and Chhattisgarh. The States Bihar, Chhattisgarh, Jharkhand and Assam are also improving their position in freshwater aquaculture production industry. Costing about 60-70% of the total expenditure related to feed stands as the most expensive component of aquaculture industry. In the current scenario, a deficiency of 69% is observed in the production-demand ratio of feed concentrate which is 44:143. For the inhabitants of the North East Indian peoples, fish has been an important food material. There is a huge gap between supply and demand as more than 95% of the population are fish eaters. During 2015-2016, this region produced 426.59 metric tons of fish with almost 50% of the fish production achieved from aquaculture. The current availability of fish in the region is estimated to be around 6.00 kg person⁻¹ year⁻¹, which is lower than the national availability of 9.00 kg person⁻¹ year⁻¹. The deficiency is estimated to be 32.6% considering 13 kg/per capita requirement of fresh fish. Currently, North East Region (NER) is importing fish from Andhra Pradesh and other States of India, in addition to import from the neighboring countries of Bangladesh and Myanmar to meet the growing demand of the people.

There has been increasing interest in upgrading food processing waste into higher value products. In India, large quantities of food and agricultural wastes are produced daily. About 40% of the agriculture products are wasted every year in India. These wastes include fruits, vegetables, cereals, and pulses. Wastage of vegetables and fruits contributes 40% economic cost of the wastage in India. All these food wastes require disposal even though most of these food waste retain some nutritious components. Thus, these wastes can be used as substrates for microbial growth to upgrade their nutritive value. For example, these wastes can be used as substrates for microbial growth to upgrade their nutritive value such as DHA and essential fatty acids productions by thraustochytrids.

Omega-3 fatty acids especially docosahexaenoic acid (DHA) and eicosapentaenoic acid (EPA) play a crucial role in larval fish survival and development. Fish relies on zooplankton, autotrophic bacteria and phytoplankton to obtain DHA as they have a low capability of synthesizing these long chain polyunsaturated fatty acids (LC-PUFAs). In aquaculture, DHA is an essential compound for the normal growth of immature fish and body coloration of adult fish. Therefore, in general, fish feed has been supplemented with fish oil enriched with DHA. In recent years, due to the decline in fish oil and fish meal production, the aquaculture industry has started to venture for alternative reliable PUFA sources. Accordingly, there is an urgent need for alternative PUFA sources in the aquaculture industry. As in recent days, thraustochytrids has been considered as an alternative source for variety of PUFA, thraustochytrids can potentially provide advantage over other available oil-based feed materials in the fish industry. To qualify as an efficient fish feed material, the feed material must compose of more proportion of DHA than EPA for the diet in most of the aquaculture species. Thraustochytrids perfectly fit with criteria as DHA content was higher than EPA content in intracellular lipids bodies of thraustochytrids. While, in general, more amount of EPA is present than DHA in most of the currently available fish feed oils used in aquaculture industries. Lipid emulsions were used to supplement live feeds to deliver DHA and other essential fatty acids to marine fish larvae.

Thraustochytrids are fungal-like heterotrophic microorganisms found in marine habitats with a high growth rate and polyunsaturated fatty acids (PUFAs) accumulation characteristics. Thraustochytrids reported to accumulate high amount of intracellular lipid bodies composed of essential fatty acids. DHA (C22:6n-3), palmitic acid (C16:0), myristic acid (C14:0), and docosapentaenoic acid (DPA) were the main fatty acids found in intracellular lipids of majority of the thraustochytrids isolates. Among the fatty acids, DHA and C16:0 occupy more than 65% of total fatty acids content in thraustochytrids. Aurantiochytrium sp. belonging to a group of thraustochytrids has been identified as a better alternative source of poly unsaturated fatty acids (PUFA) in the food industry. Under synergetic culture conditions, the Aurantiochytrium strains reported to accumulate up to 50% lipid bodies (of its dry weight) in which half of the fatty acids were composed of DHA. Some micronutrients are required in order to improve the biomass and DHA yield of thraustochytrids. Environmental factors such as culture media composition, salinity and temperature have a great influence in the DHA content in thraustochytrids. The lipid composition and the biomass production were also influenced by the composition of the growth media, thus also affecting the yield of DHA. Thraustochytrids were able to grow on different inorganic/organic nitrogen and organic carbon sources. In thraustochytrids production and fermentation media, the carbon source was the most expensive component, thereby the production cost of the thraustochytrids DHA was highly dependent on the price of the carbon source used. The profitability of thraustochytrids DHA production can be increased by development of low cost carbon sources. For DHA production from thraustochytrids, industrial and agricultural wastes have always come up as alternative carbon sources. To date, sweet sorghum juice, wheat straw, starch from corn, sugar cane bagasse, raw glycerol, food wastes and various industrial wastes have been investigated as alternative carbon sources for the growth of thraustochytrids.

Earlier studies indicated that when cultured on sugarcane bagasse hydrolysate and related substrates, Aurantiochytrium sp. was able to produce single cell oil (SCO) rich in DHA [Iwaska et al. 2013; Yu et al. 2015]. Another study utilized brewery industrial waste as a carbon source to culture Aurantiochytrium sp. for the production of DHA [Kim et al. 2013]. Aurantiochytrium sp. had been grown in a solid state fermentation (SSF) of orange peel for the enhanced production of DHA [Park et al. 2018]. High levels of DHA and better cell growth and intracellular lipid accumulation was observed in Aurantiochytrium sp. when cultured in palm oil empty fruit bunches, a by-product of the palm oil industry [Hong et al. 2013].

In U.S. Pat. No. 6,977,167B2, Thraustochytrid strains, Thraustochytrium or Schizochytrium were isolated and characterized for omega-3 fatty acids production. In one aspect, fatty acids production was carried out in this invention in different carbon sources including corn starch, ground corn, molasses, wheat starch and potato starch. One of the strain Thraustochytrium was found to directly ferment ground and un-hydrolyzed grain to produce omega-3 highly unsaturated fatty acids (HUFA). After fermentation, harvested biomass can be used as a feed material. However, the invention has not utilized any fruit peel wastes for the thraustochytrids growth and fatty acids production. The invention has also not reported for the combination of different carbon sources studied. Moreover, separation is essential in the invention which is in fact an energy consuming and expensive process as compared to utilizing whole fermented composite as feed material.

In one aspect of U.S. Pat. No. 7,022,512B2, omega-3 highly unsaturated fatty acids producing Thraustochytrium or Schizochytrium or mixtures mixed with agricultural product flaxseed, rapeseed, soyabean, avocado meal, and mixtures were used as feed material for aquaculture. However, the invention has not utilized any fruit peel wastes for the thraustochytrids growth and fatty acids production. Further, separation is essential in the invention which is in fact an energy consuming and expensive process as compared to utilizing of whole fermented composite as feed material.

In one aspect of U.S. Pat. No. 5,908,622, the agricultural product flaxseed, rapeseed, soyabean, avocado meal, and mixtures with omega-3 highly unsaturated fatty acids producing Thraustochytrium or Schizochytrium or mixtures were also fermented for the development of feed for aquaculture. However, the invention has not utilized any fruit peel wastes for the thraustochytrids growth and fatty acids production. Further, separation is essential in the invention which is in fact an energy consuming and expensive process as compared to utilizing of whole fermented composite as feed material.

The United States Patent US20180103659A1 claims for the creation of transgenic plant materials that produces lipids comprised of at least 5.5% steariodonic acid (SDA) as feed for aquaculture. For transgenic plant cell lines creation, a gene from thraustochytrids strain which encodes Δ6 desaturase or omega3 desaturase or Δ15 desaturase was expressed in canola, soybean, flax, other oilseed plants, cereals or grain legumes. However, the study utilized transgenic plant materials with foreign microbial gene which requires regulatory clearance for direct usage for human and animal consumption. Moreover, the effect of transgenic feed material needs to be closely monitored in the primary and secondary consumers. The primary consumer here refers to “fish” and secondary consumer here refers to “human”.

In some embodiments of the U.S. Pat. No. 10,308,965B2, microorganisms belong to thraustochytrid family, preferably Schizochytrium, Thraustochytrium or Ulkenia were used to ferment with the cellulose derived from any of the following biomasses, grass, sugar cane, agricultural waste, waste paper, sewage, wood, an organism of the kingdom viridiplantae, and combinations for the fatty acids production to be used as feed stock materials. However, in this invention, thraustochytrid strains utilized the cellulose which derived from different biomasses. None of the raw biomasses have been used as they are for the thraustochytrids growth or fatty acids production.

One preferred process of the United States Patent US2006/0188969A1 found that Schizochytrium or Thraustochytrium strain was able to ferment some grains and waste products such as corn, sorghum, rice, wheat, oats, rye and miller for the production of omega-2 HUFA. However, in this invention, the grains used were first partially hydrolyzed before fermentation with thraustochytrids strains. For this pre-treatment, enzymes such as amylase, amyloglucosidase, alpha or beta glucosidase, or a mixture of these enzymes were used. The resulting hydrolyzed grains were used for microbial fermentation for fatty acids production. The enzymatic hydrolysis in the invention is an expensive process considering the price of hydrolytic enzymes used. Moreover, scale-up of enzymatic hydrolysis is a highly challenging and high cost-consuming process.

The international patent WO2014/137538AS partly describes the production of DHA and EPA in Schizochytrium, Thraustochytrium, Ulkenia and/or other Labyrinthulea strains when crude glycerol is used as a substrate. Part of the process in this invention utilized crude glycerol as a portion in culture medium for the growth of the above mentioned. In the invention, crude glycerol was obtained by processing biodiesel.

The major drawbacks of the prior arts is that none of studies have utilized fruit peel wastes as a source for thraustochytrids growth and fatty acids (omega-3: DHA and EPA) production. The earlier arts are also either difficult or expensive processes for industrial-level scale-up. Cost effective production of biomass as well as omega-3 fatty acids (DHA and EPA) can be achieved by studying the cultivation of thraustochytrids using organic wastes. As fruits such as orange, pineapple and banana were rich in nutrient sources, the wastes (peels) of fruits can potentially serve as an alternative carbon source in thraustochytrids production media. Thus, a novel, eco-friendly, inexpensive, and easy to scale-up method for aquaculture feed development is needed. Moreover, the strategy must fit with the sustainable development goals (SDG) of United Nation (UN). In this regard, nutritional enrichment of fruit peel wastes with omega-3 fatty acids producing thraustochytrids strains is an eco-friendly, zero-waste and solid waste management system.

### OBJECTIVES OF THE INVENTION

The main objective of the present invention is to provide a fruit peel wastes-based composite as a feed product for aquaculture farms and industries. The invention uses different types of fruit peel wastes namely pineapple, banana, orange, and mausambi peels to create a composite using response surface methodology. The composite can potentially be used as a base feed material in aquaculture farms.

Another major objective of the present invention is to use omega-3 fatty acids (DHA) producing thraustochytrids to nutritionally enrich fruit peel wastes-based composite which can be directly used as feed for aquaculture farms.

Yet another objective of this invention is to synergize Solid State Fermentation (SSF) conditions suitable for the creation of fruit peel wastes-based composite and their nutritional enrichment using PUFA producing microorganisms.

Yet another objective of the invention is to improve the total protein concentration of nutritionally-enriched SSF composite material to at least about 30% or 40% using soyabean husk or soyabean which resulted the final product comprised of essential nutrient (omega-3 fatty acids, proteins and crude fibre) to qualify as fish feed.

Still another objective of the present invention is to provide a process that is eco-friendly, zero-waste, cost-effective, facile, and solid waste management system for creation of nutritionally enriched fruit peel wastes-based composite feed material for aquaculture farms.

### SUMMARY OF THE INVENTION

Accordingly, the present invention provides a fruit peel wastes-based composite as a feed product for aquaculture farms and industries. The composite consists of fruit peel wastes (pineapple, banana, orange, and mausambi peels) generated using response surface methodology, and successfully enriching with omega-3 fatty acids derived from thraustochytrids strain Aurantiochytrium sp. ATCC279 in a solid state fermentation (SSF) condition. The protein content of fermented product is further improved using soyabean husk or soyabean. The final composite material contains the entire essential nutrient necessary to qualify as feed for aquaculture.

The present invention provides an easy, rapid and cost-effective creation of feed for aquaculture farms. Creation of low-cost, eco-friendly feed material specific for aquaculture is extremely important as feed alone occupies 66% of production cost in the aquaculture industries and a steady decline in the conventional fish feed material derived out of fish oil.

In an embodiment of the present invention, fruit peel wastes including pineapple peels, banana peels, orange peels and mausambi peels were collected, dried and powdered for the preparation of composite material.

In another embodiment of the present invention, combinations of different fruit peels-based composite containing pineapple, banana, orange and mausambi based composite were derived using response surface methodology.

In another embodiment of the present invention different fruit peels-based composite was nutritionally enriched with omega-3 fatty acids of thraustochytrids cells using solid state fermentation.

In another embodiment of the present invention there is further improvement in the protein content of the nutritionally enriched fermented composite material with soyabean husk or soyabean. Thus, the final product of the present invention will be an eco-friendly, cost-effective, zero-waste material suitable to use as feed in aquaculture farms.

In an embodiment of the present invention, it provides a fruit peel wastes-based composite as a feed product for aquaculture farms and industries characterized in having:
a. Total Lipid Content—20% to 30%
b. Microbial Lipid Content—8% to 10%
c. Carbohydrates—2.6% to 4.2%
d. Crude Fibre—6.0% to 7.0%
e. Phosphorus—0.10% to 0.22%
f. Protein Content—30% to 40%
g. Ash content—14.5% to 16.5%
h. Ascorbic Acid Content—0.10% to 0.12%

In an embodiment of the present invention, a composite is provided, wherein the composite is prepared from fruit peels selected from the group consisting of pineapple, banana, orange and mausambi in the ratio of 0.8 to 1.5:1.5 to 2.10:2 to 3:1.10 to 1.40 along with 20% Aurantiochytrium seed cells.

In an embodiment of the present invention, a composition is provided, wherein the composite is prepared by the method comprising the steps:
i) obtaining pineapple, banana, orange and mausambi peels,
ii) drying the peels obtained in step (i) in a temperature range of 25° C. to 30° C. and powdering it to obtain peels powders,
iii) mixing the peels powders obtained in step (ii) in the ratio 0.8 to 1.5:1.5 to 2.10:2 to 3:1.10 to 1.40 in a temperature range of 25° C. to 30° C. to form a composite, and sterilization of the composite,
iv) lipid enrichment of the composite obtained in step (iii) with Aurantiochytrium by fermentation at 20° C.-30° C. to obtain a fermented composite, and
v) mixing the fermented composite obtained in step (iv) with soyabean and soyabean husk to adjust the total protein concentration of the fermented composite in the range of 30% to 50%.

In an embodiment of the present invention, a composition is provided which is pelleted in the size range of 1.00 mm to 3.00 mm.

In an embodiment of the present invention, a composition is provided which is useful as a fish feed.

### BRIEF DESCRIPTION OF THE DRAWINGS

FIG. 1. Bar graphs representing the glucose and maltose contents in different fruit peels. 1. orange peels, 2. banana peels, 3. pineapple peels, 4. mousambi peels, 5. mixture of all four peels (1:1:1:1 ratio), 6. mixture of orange and mousambi peels (1:1 ratio), 7. mixture of banana and pineapple peels (1:1 ratio).

FIG. 2. Growth curve of Aurantiochytrium sp. in full-strength nutrient medium.

FIG. 3. Growth curves (cell count) in the nutrient medium composed of 2 g/L yeast extract, 30 g/L peptone with the supplementation of pineapple, banana, orange, mousambi peels, separately. Nutrient medium without glucose supplementation was maintained as control. All data is presented as mean±standard deviation. Growth curves of Aurantiochytrium sp. ATCC276 in nutrient media supplemented with orange peels (♦); Aurantiochytrium sp. ATCC276 in nutrient media supplemented with pineapple peels ( [symbol] ); Aurantiochytrium sp. ATCC276 in nutrient media supplemented with mousambi peels (▴); Aurantiochytrium sp. ATCC276 in nutrient media supplemented with banana peels (-); Aurantiochytrium sp. ATCC276 in nutrient media without glucose (●).

FIG. 4. (a) Bar graphs representing the glucose and maltose contents in SSF materials enriched with Aurantiochytrium sp. ATCC276. Control: the SSF materials without Aurantiochytrium sp. ATCC276. White and black bars representing the control and test of 4-component SSF system, respectively. Gray and dot bars represent the control and test of 2-component SSF system, respectively. (b) statistical comparisons of glucose utilization levels between 4 and 2-component systems inoculated with Aurantiochytrium sp. ATCC276. (c) statistical comparisons of maltose utilization levels between 4 and 2-component systems inoculated with Aurantiochytrium sp. ATCC276. All statistical data were calculated in mean±standard deviation. Error bar represents the standard deviation of the sample. The level of significance was performed by two-way ANOVA test (**p<0.0074). Asterisk symbol indicates significant differences.

FIG. 5. (a) Bar graphs representing the total lipid content and enrichment levels of 4 and 2-component SSF materials. White and dark gray bars representing enrichment levels compared to respective controls in 4 and 2-component systems. (b) statistical comparisons of lipid enrichment levels compared to respective controls in 4 (black bars) and 2 (gray bars) component systems. (c) statistical comparisons of lipid enrichment levels between 4 (black bars) and 2 (gray bars) component systems. All statistical data were calculated in mean±standard deviation. Error bar represents the standard deviation of the sample. The level of significance was performed by two-way ANOVA test (***p<0.0005, **p<0.0088). Asterisk symbol indicates significant differences.

### DETAILED DESCRIPTION

Aurantiochytrium sp. ATCC PRA-276 was purchased from the American Type Culture Collection (ATCC, Baltimore, MD). The cells were maintained in 30% (v/v) glycerol stock (Sigma St. Louis, USA) at −65° C. The seed cultures of ATCC276 were prepared in full-strength medium containing 2 g/L yeast extract, 30 g/L peptone, 20 g/L glucose (Himedia, India) supplemented with artificial sea water (ASW). The seed cultures were maintained at 25° C. Aurantiochytrium sp. ATCC276 produces higher levels of PUFA mainly composed of DHA (C22:6 ω3) and DPA (DPA, 22:5 ω6). Of intracellular fatty acids accumulated in ATCC276, DHA corresponds to 29% (w/w).

Further, the composite is nutritionally enriched using omega-3 fatty acids producing thraustochytrids in Solid State Fermentation (SSF) conditions. The process includes synergizing SSF condition suitable for nutritional enrichment of fruit peel wastes-based composite with omega-3 fatty acids producing thraustochytrids. At the end of the disclosed SSF fermentation process, the final composite product was enriched with microbial-derived omega-3 fatty acids, protein and fibre contents. Therefore, the final nutritionally enriched fruit peel wastes-based composite had fulfilled all essential nutrient contents necessary to qualify as feed for aquaculture farms. Moreover, the disclosed invention introduces the reuse concept of discarded agricultural (fruit peels) wastes for fermentation with omega-3 fatty acids producing microorganisms thereby it is a development of eco-friendly, zero-waste and solid waste management system.

### EXAMPLES

The following examples are given by way of illustration and therefore should not be construed to limit the scope of the invention.

### Example 1

Fruit peels of orange (Citrus sinensis), mausambi (Citrus limetta), pineapple (Ananas comosus), and banana (Musa gigantean) were collected from the market areas located at Naharlagun 791110, Arunachal Pradesh. The fruit peels were washed twice with sterilized distilled water and placed under day-light sun until completely dried. The dried fruit peels were ground into powder separately and stored in the laboratory.

The proximate composition of the fruit peels is presented in Table 1.

TABLE 1
Proximate compositions of different fruit peels

| | Proximate analysis | | | | | | | |
|---|---|---|---|---|---|---|---|---|
| | Nitrogen | Phosphorus | Protein | Carbohydrate | Fat | Ascorbic acid | Crude fibre | Ash |
| | contents | contents | contents | contents | contents | contents | contents | contents |
| Fruit peels | (%) | (%) | (%) | (%) | (%) | (mg/100 g) | (%) | (%) |
| Citrus × chinensis | 0.73 ± 0.1 | 0.24 ± 0.01 | 4.55 ± 0.12 | 9.44 ± 0.3 | 6.81 ± 0.1 | 0.165 ± 0.42 | 17.09 ± 0.3 | 2.96 ± 0.4 |
| (Orange) | | | | | | | | |
| Citrus limetta | 0.32 ± 0.1 | 0.12 ± 0.01 | 2.01 ± 0.1 | 14.28 ± 0.13 | 4.19 ± 0.1 | 0.190 ± 0.5 | 22.73 ± 0.41 | 4.01 ± 0.23 |
| (Mausambi) | | | | | | | | |
| Ananas comosus | 1.09 ± 0.1 | 0.20 ± 0.002 | 6.78 ± 0.2 | 16.09 ± 0.3 | 1.24 ± 0.1 | 0.048 ± 0.35 | 6.08 ± 0.2 | 3.47 ± 0.1 |
| (Pineapple) | | | | | | | | |
| Musa chinensis | 1.34 ± 0.1 | 0.05 ± 0.001 | 8.36 ± 0.2 | 10.76 ± 0.2 | 8.81 ± 0.05 | 0.018 ± 0.6 | 5.52 ± 0.34 | 17.31 ± 0.3 |
| (Banana) | | | | | | | | |

The protein content of the fruit peels ranged from 2.01% to 8.36%. The lowest level of content was found in mausambi and the highest content was obtained for banana. The carbohydrate contents of the different fruit peels varied from 9.44% to 16.09%. Total lipid content in the fruit peels varied from 1.25% to 8.81%. The ash content in the fruit peels ranged from 2.96% to 17.31%. The level of crude fibre content in the fruit peels varied from a maximum of 22.73% in mausambi to a minimum of 5.52% in banana. The present study identified 1.09% of phosphorus content in pineapple peels. The total ascorbic acid content in the fruit peels varied from 0.190 mg/100 g to 0.018 mg/100 g. During environmental stress, reactive oxygen species (ROS) were reported to inhibit thraustochytrids growth and fatty acids accumulation. However, this major limitation can be overcome by exogenous supply of limited quantities of antioxidants such as ascorbic acid in the culture medium. The limited availability of ascorbic acid in fruit peels can potentially scavenge the accumulation of intracellular ROS in thraustochytrids cells thereby supports thraustochytrids growth and fatty acids production in the SSF conditions. In this study, highest concentration (1.34%) for nitrogen content was observed in peels of banana followed by 1.1% in pineapple, 0.73% in orange, and 0.32% in mausambi.

### Example 2

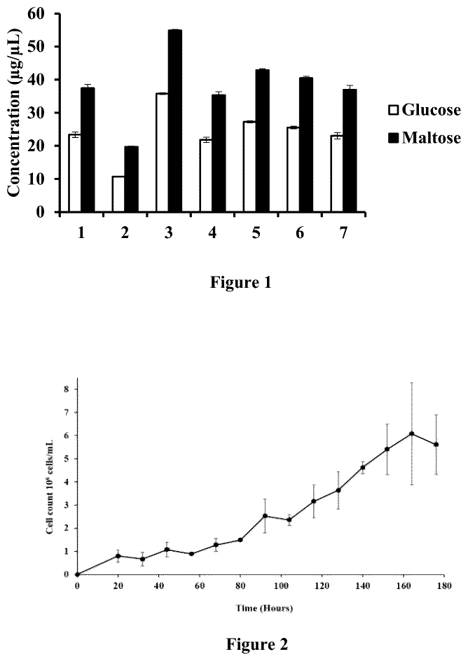

Quantitative analysis of reducing sugars (glucose and maltose) in the fruit peels was carried out using dinitrosalicyclic acid (DNS) method. HPLC-grade glucose and maltose were used as standards for DNS analysis. In detail, 100 μL of fruit peel samples were separately dissolved in 1 mL of dinitrosalicyclic acid (Himedia, India) and adjusted to a final volume of 2 mL with distilled water. The solution was kept in boiling water bath for 15 mins, and cooled to room temperature. The reducing sugars were determined by measuring the absorbance at 540 nm using a spectrophotometer (BioSpectrometer basic, Eppendorf, Germany). The results of quantitative measurement of reducing sugars in peels are shown in FIG. 1. The pineapple peels were observed to have the highest concentrations of glucose (35.8 mg/g) and maltose (54.86 mg/g). The glucose concentration obtained in this study was 23.64 mg/g. The glucose content obtained for orange, banana and mausambi was 23.26, 10.7, and 21.71 mg/g, respectively. Whereas, maltose concentration of 37.44, 19.7, and 35.3 mg/g was observed for orange, banana and mausambi, respectively. Reducing sugars analysis of 1:1:1:1 mixture consists of all 4 peels showed a concentration of 27.252 mg/g and 42.89 mg/g of glucose and maltose, respectively. A 1:1 mixture of pineapple and banana peels showed the reducing sugars contents of 26.96 mg/g for glucose and 42.49 mg/g for maltose.

### Example 3

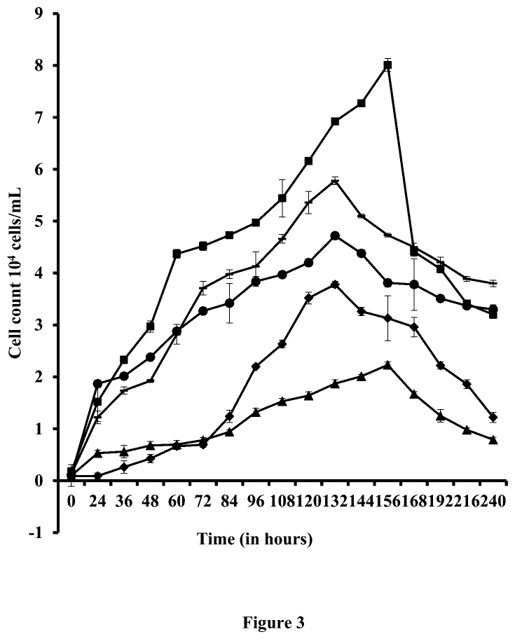

Before investigating the physiology of Aurantiochytrium sp. ATCC276 in SSF, the physiological behavior of the strain was characterized for the growth and intracellular accumulation of lipid bodies in the synthetic full-strength culture medium. FIG. 2 shows the growth curve of Aurantiochytrium sp. ATCC276 in the culture medium. Aurantiochytrium sp. ATCC276 had a steady-state lengthy exponential growth phase that started from 12 h and ended in 140 h. The strain reached the stationary phase by 160 h and growth reduced in 180 h. The evaluation of growth of Aurantiochytrium ATCC276 was carried out in modified culture medium comprising of different fruit peels. The growth evaluation experiments consisted of 4 different conditions in the modified culture medium containing i) 2 g/L yeast extract, 30 g/L peptone+pineapple peels, ii) 2 g/L yeast extract, 30 g/L peptone+banana peels, iii) 2 g/L yeast extract, 30 g/L peptone+orange peels, iv) 2 g/L yeast extract, 30 g/L peptone+mausambi peels. Following control was maintained separately, i) 2 g/L yeast extract, 30 g/L peptone without glucose. The individual concentrations of fruit peels were determined to pave a way to supply 2% glucose for the culture medium from their respective glucose content. The cultures were incubated at 25° C. The cell count of the culture was taken at different intervals of time using hemocytometer (Sigma-Aldrich, St. Louis, MO). All experiments were performed in triplicates. The results of assessment of thraustochytrids adaptation in individual fruit peels are available in FIG. 3. When pineapple peel was exogenously supplied in the medium, better cell counts for ATCC276 were obtained compared to control medium without glucose. After pineapple peel, the exogenous supply of banana peel in the medium was found to support the growth of ATCC276 better. Surprisingly, the opposite was observed when media supplemented with orange and mausambi peels, separately. As a control, the growth of ATCC276 in culture medium containing yeast extract and peptone but without glucose was studied. The control medium yielded moderately growing ATCC276 cells, but the cell counts were less than those observed in media supplemented with pineapple and banana peels, separately. It was interesting to observe that both pineapple and banana peels separately supported the ATCC276 growth better in culture medium when exogenously supplemented. The negative results obtained for orange and mausambi peels supplemented media may be due to the presence of high content of crude fibre in the respective peel materials. Other oleaginous microorganisms such as oleaginous yeast and fungi have been evaluated for their valorization capacity of agri-waste peel materials from different sources.

### Example 4

RSM based face-centered cubic design (FCCD) was used to synergize the lipid production using different fruit peel wastes. In the experiments, the four factors (fruit peel waste g/100 mL) were used, namely, orange (A), mausambi (B), pineapple (C), and banana (D). The range and levels of the variables investigated in this study are given in Table 2.

TABLE 2
Combination of design matrix composed of different concentrations
of different fruit peels for lipid production. All the experiments
contained (per 100 mL) 0.2 g yeast extract and 3 g of peptone.

| Std. | Variables (g/100 mL) | | | | Experimental values |
|---|---|---|---|---|---|
| order | Orange | Mausambi | Pineapple | Banana | Lipid enrichment (%) |
| 1 | 11 | 7 | 6 | 10 | 5.8 |
| 2 | 9 | 9 | 4 | 8 | 8 |
| 3 | 13 | 5 | 4 | 12 | 6.6 |
| 4 | 13 | 9 | 4 | 12 | 6.3 |
| 5 | 13 | 9 | 8 | 12 | 7.6 |
| 6 | 13 | 5 | 8 | 8 | 5 |
| 7 | 9 | 9 | 8 | 8 | 5.3 |
| 8 | 11 | 7 | 6 | 10 | 5.8 |
| 9 | 11 | 7 | 6 | 8 | 7.3 |
| 10 | 11 | 7 | 4 | 10 | 7.6 |
| 11 | 13 | 5 | 4 | 8 | 4.3 |
| 12 | 9 | 7 | 6 | 10 | 4.6 |
| 13 | 9 | 5 | 8 | 12 | 8 |
| 14 | 13 | 9 | 4 | 8 | 7.3 |
| 15 | 13 | 7 | 6 | 10 | 6.6 |
| 16 | 11 | 7 | 6 | 10 | 5.8 |
| 17 | 11 | 7 | 8 | 10 | 5 |
| 18 | 9 | 5 | 4 | 8 | 8.3 |
| 19 | 11 | 9 | 6 | 10 | 8 |
| 20 | 13 | 5 | 8 | 12 | 5 |
| 21 | 11 | 5 | 6 | 10 | 7.3 |
| 22 | 11 | 7 | 6 | 10 | 5.8 |
| 23 | 13 | 9 | 8 | 8 | 5.3 |
| 24 | 9 | 5 | 8 | 8 | 7.3 |
| 25 | 9 | 9 | 8 | 12 | 8 |
| 26 | 9 | 9 | 4 | 12 | 5 |
| 27 | 11 | 7 | 6 | 12 | 6.6 |
| 28 | 11 | 7 | 6 | 10 | 5.8 |
| 29 | 9 | 5 | 4 | 12 | 6.3 |
| 30 | 11 | 7 | 6 | 10 | 5.8 |

The data obtained at each step were analyzed using the software Design-Expert 12. A mathematical model was developed to describe the relationships between the process indices (lipid content %) and the range and levels of the experiments in the second-order equation (Eq. 1). The lipid enrichment of Aurantiochytrium sp., was multiply regressed with respect to different organic fruit peel waste using the least-squares method as follows:

$$\text{?} \qquad ( Eq \text{.1} )$$

$$\text{?} \text{indicates text missing or illegible when filed}$$

Where y is the response surface, xi and xj are the input variables, xi2 and xi and xj are quadratic and interaction terms of input variables, respectively. The ai, aii and aij are unknown regression coefficients. The coefficients of the response surface have been estimated by using the proposed scheme of the face-centered in the central composite design.

A set of 30 experimental combinations contained different compositions of fruit peels, yeast extract (0.2 g/100 mL), and peptone (3 g/100 mL) were designed using RSM (Table 2). The combinations were supplemented with artificial sea water. Aurantiochytrium seed was prepared as mentioned above. Seed 20% was used for solid state fermentation (SSF) studies. Controls were maintained without the supplement of Aurantiochytrium cells. The SSF samples were incubated at 25° C. for 10 days. After the incubation period, the lyophilized samples were used for the lipid content analysis. The total lipids were extracted from 300 mg of lyophilized SSF samples with a chloroform-methanol (2:1 v/v) solvent mixture using a procedure similar to Folch's method. Based on results obtained from RSM analysis, the best performing SSF combination was selected for model validation experiments.

### Example 5

The diagnostic checking of the developed RSM of Aurantiochytrium sp. ATCC276, for lipid production using different fruit peel waste has been performed using model adequacy, normality, and independence based on the residual analysis. The FCCD and the corresponding experimental data are available in Table 3. Table 3 shows the analysis of variance (ANOVA) for the experiment.

TABLE 3
Analysis of variance of lipid production by
Aurantiochytrium sp. ATCC276 using different
concentration and combinations of fruit peel waste

| Source | Sum of squares | df | Mean square | F value | p-value |
|---|---|---|---|---|---|
| Total model | 21.90 | 14 | 1.56 | 1.30 | 0.2823 |
| A-Orange | 2.57 | 1 | 2.57 | 2.11 | 0.1670 |
| B-Mausambi | 0.40 | 1 | 0.40 | 0.33 | 0.5727 |
| C-Pineapple | 0.57 | 1 | 0.57 | 0.47 | 0.5048 |
| D-Banana | 0.094 | 1 | 0.094 | 0.075 | 0.7851 |
| AB | 5.29 | 1 | 5.29 | 4.34 | 0.0547 |
| AC | 0.42 | 1 | 0.42 | 0.34 | 0.5647 |
| AD | 1.69 | 1 | 1.69 | 1.40 | 0.2572 |
| BC | 2.500E−003 | 1 | 2.500E−003 | 2.0E−003 | 0.9645 |
| BD | 7.105E−015 | 1 | 7.105E−015 | 5.834E−015 | 1.0000 |
| CD | 5.52 | 1 | 5.52 | 4.53 | 0.0502 |
| Residual | 18.27 | 15 | 1.22 | | |
| Lack of Fit | 18.27 | 10 | 1.83 | | |
| Pure Error | 0.0000 | 5 | 0.0000 | | |
| Cor Total | 40.17 | 29 | | | |

It was evident that experimental values of % lipid are in close agreement with the values predicted by central composite design. Moreover, the lipid production capability of Aurantiochytrium sp. ATCC276 was determined and ANOVA was used to obtain the interaction between the process variables and the responses. The overall total model was indicated not significant at p<0.001. The coefficient of determination (R²) of lipid percentage was 0.5424, (adjusted R², 0.1206) which indicates that 54.24% of the variability in the response can be accounted for by the model. A quadratic order equation was used as suggested by the software for analyzing the responses. The quadratic model for the lipid production (%) was regressed and expressed as Equation 1:

$$Lipid ( \% ) = + 2 7.39375 + 3.38874 * Orange - 5.38355 * Mausambi - 0.37836 * Pineapple - 3.80468 * Banana + 0.14375 * Orange * Mausambi - 0.040625 * Orange * Pineapple + 0.08125 * Orange * Banana - 0.003125 * Mausambi * Pineapple + 1.30829 E - 16 * Mausambi * Banana + 0.14688 * Pineapple * Banana - 0.23421 * {Orange}^{2} + 0.27828 * {Mausambi}^{2} - 0.05921 * {Pineapple}^{2} + 0.1 \; 03289 * {Banana}^{2}$$

The residual plot for the response parameter of the material accumulation rate can be inferred that the residuals are spread approximately in a straight line, which shows a moderate correlation between experimental and predicted values and the variable follows the normal distribution. From RSM, it can be inferred that the errors are normally distributed. From RSM, it can be deduced that the residuals are randomly scattered indicating that they are independent.

Though statistically incidental lipid production was observed when adding different fruit peels in the medium, however, there were some noticeable changes in the lipid enrichment in some combinations of fruit peel addition. For instance, RSM shows the lipid production has reached the maximum of 7% at the minimum concentration of the peel wastes of orange and mausambi (9 and 5 g/100 mL), respectively. Whereas, the high concentration of peel waste was reduced the lipid accumulation and observed only 5% in orange peel waste (13 g/100 mL). The production of lipid was not changed significantly towards the addition of fruit peel waste of orange and pineapple in the medium. The production of lipid was maximum of 7% at the minimum concentration of the peel waste of mausambi and pineapple (5 and 4 g/100 mL), respectively. A similar amount of lipids was observed towards the high concentration of respective peel waste used (13 and 8 g/100 mL). Result shows the interaction of peel waste of mausambi and banana on lipid accumulation, which supported lipid enrichment at a maximum of 7.5% at the highest concentration of waste added. For instance, 9 g/100 ml for mausambi and 12 g/100 mL for banana. There were no noticeable interactions on the lipid accumulations in the addition of different concentrations of pineapple and banana peel waste in the medium. Overall, the results indicated that the addition of mausambi and orange, mausambi and pineapple, mausambi, and banana could improve the lipid enrichment at the maximum. Therefore, the SSF combination was further characterized for sugar utilization and lipid enrichment levels.

### Example 6

Experiments were performed to validate the RSM predicted maximal lipid accumulation by adding different fruit peel waste. RSM software suggested the maximized lipid production of 8.30% at orange 9.91 g 100 mL⁻¹, mausambi 5 g 100 mL⁻¹, pineapple 4.12 g 100 mL⁻¹, and banana 8.01 g 100 mL⁻¹. Table 4 shows the experimental result (8.37%) was comparable with those predicted (8.30%) using RSM and therefore validated the findings of response surface optimization. The moisture level in this optimized condition was calculated to be 78.72% (27.04 g*100/(100+27.04 g)). Accordingly, the solid content was calculated to 21.28% in this optimized condition. In general, the moisture level in SSF condition may vary between 30 to 80%. Typical moisture content for the most of microbe-derived enzyme production in SSF condition was 60%. Therefore, the synergized condition of this study can be termed as SSF.

TABLE 4
SSF conditions for Aurantiochytrium-based lipid
enrichment in fruit peels-based SSF.

| | | | | Lipid |
|---|---|---|---|---|
| Variables (g/100 mL) | | | | enrichment |
| Orange | Mausambi | Pineapple | Banana | (%) |

Model predicted:

| 9.91 | 5 | 4.12 | 8.01 | 8.30 |
|---|---|---|---|---|
| Experimental results: | | | | |
| SSF material | | | | |
| 9.91 | 5 | 4.12 | 8.01 | 8.37 ± 0.54 |

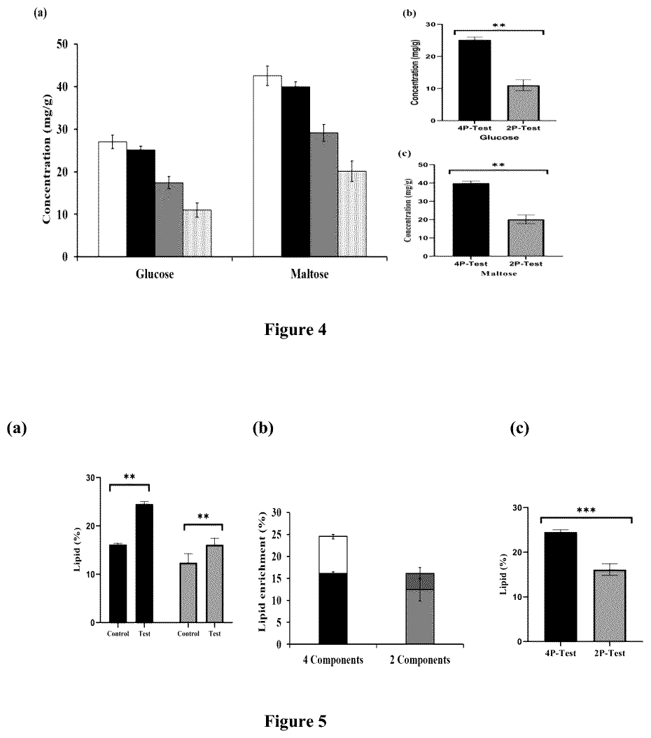

The reducing sugars (glucose and maltose) contents in microbially-enriched SSF material and control were analyzed as described above. As shown in FIG. 4. glucose (6.99%; 2.0 mg/g) and maltose (6.22%; 2.7 mg/g) components of SSF material were efficiently utilized by Aurantiochytrium sp. ATCC276, compared to the control. This observation endorsed that ATCC276 efficiently utilizes the sugar components in the SSF material for their growth and intracellular lipid accumulation.

### Example: 7

For visualization of microbial lipid bodies in the SSF materials, microbially-enriched SSF materials were studied using fluorescent dye BODIPY 505/515 (4,4-difluoro1,3,5,7-tetramethyl-4-bora-31,41-diaza-s-indacene; Aldrich, St. Louis, MO) and confocal microscopy. BODIPY 505/515 staining was performed as follows: 5 mM BODIPY 505/515 stock was prepared by dissolving in dimethyl sulfoxide (DMSO, Sigma Aldrich, St. Louis, MO) and stored in the dark. For efficient staining of Aurantiochytrium-accumulated lipids in SSF, 0.2% DMSO (aliquot) was added into a small portion of SSF samples, followed by addition of 2 μL BODIPY 505/515 solution into the SSF materials. The samples were then incubated in darkness for 5 mins at room temperature. The samples were visualized using laser scanning confocal microscopy (TCS SP8 SMD, Leica, Mannheim, Germany) with the emission set at 500-579 nm and the excitation set at 358 nm. According to the protocol provided by the manufacturer, the quantitative analysis of the digitized images was carried out using Leica Applied System X (LASX) software.

Since 8.37% lipid enrichment was observed in the SSF materials, lipid enrichment in SSF materials was further characterized (FIG. 5, Table 4). The absolute amount of lipid accumulation in the SSF was 34.29%. The SSF materials consist of relatively better glucose versus maltose variation. It was also noted here that SSF materials consist of a high proportion of orange peels, and a high quantity of fructose was observed in orange peels. Therefore, it may be a convincing observation that proportions of glucose and fructose induced high-level accumulation of intracellular lipid bodies in ATCC276 in SSF materials.

The proximate composition of SSF materials is shown in Table 5.

TABLE 5
Proximate analysis of 4 and 2-components SSF materials

| | Samples | | | | | | |
|---|---|---|---|---|---|---|---|
| | Phosphorus content | Ash content | Carbohydrate | Ascorbic acid | Nitrogen | Protein | Crude |
| SSF system | (in %) | (in %) | (in %) | (in mg/100 g) | (%) | (%) | fibre |
| Control | 0.13 ± 0.004 | 15.0 ± 0.14 | 4.0 ± 0.7 | 0.11 ± 1.4 | 0.85 ± 0.06 | 5.34 ± 0.37 | 6.6 ± 0.3 |
| Test (inoculated | 0.20 ± 0.0172 | 16.0 ± 0.28 | 2.6 ± 0.48 | 0.11 ± 4 | 0.95 ± 0.08 | 5.95 ± 0.53 | 6.3 ± 0.3 |
| with ATCC276) | | | | | | | |

It was observed that the carbohydrate content of SSF materials was significantly reduced (4.0±0.7% to 2.6±0.48%) in test after the inoculation of ATCC276. This observation further supports the finding of the reducing sugar analysis. Therefore, it is certain that ATCC276 cells were efficiently utilizing the available nutrient sources in the SSF condition for their growth and intracellular lipid accumulation (8.37±0.54% and 3.7±1.32% enrichment in optimized SSF systems). A slight decrease in protein content of optimized SSF materials was observed in the SSF materials after incubation with ATCC276 cells. There were no significant differences observed for nitrogen and ash content in the SSF materials after incubation with ATCC276 cells.

At last, the SSF materials enriched with microbially-derived omega-3 fatty acids were mixed with soyabean husk or soyabean to further modify and improve the total protein content of the composite to at least about 30% or 40%.

### Comparative Table

Microbial lipid enrichment in the growth medium composed of 2 g/L yeast extract, 30 g/L peptone with the supplementation of pineapple, banana, orange, mausambi peels, separately, as well as synergistically.

| | Microbial lipid |
|---|---|
| Conditions | enrichment (%) |
| Media supplemented with orange peels and | 4.02 |
| Aurantiochytrium sp. ATCC276 | |
| Media supplemented with pineapple peels and | 0.5 |
| Aurantiochytrium sp. ATCC276 | |
| Media supplemented with mousambi peels | 2.81 |
| and Aurantiochytrium sp. ATCC276 | |
| Media supplemented with banana peels and | 4.43 |
| Aurantiochytrium sp. ATCC276 in | |
| composite composed of orange + pineapple + | 8.37 |
| mousambi + banana peels and | |
| Aurantiochytrium sp. ATCC276 | |

### Advantages

1. The main advantage of the present invention lies in that the nutritionally-enriched fruit peel waste composite can be directly supplemented as feed to provide an improved source of omega-3 fatty acids for better growth of fish which provides highly significant advantages over conventional sources.
2. As the invention utilizes fruit peel wastes for the fermentation process and feed development, the invention is a highly sustainable eco-friendly, zero-waste and solid-waste management system which in fact falls under Sustainable Development Goals (SDG) of United Nations (UN).
3. The use of locally available fruit peel wastes as raw material reduces the significant amount of cost-associated with fish production expenditures and thus provides more benefits to the farmers and entrepreneurs.
4. The supplement of omega-3 fatty acids enriched feed enables the farmer to bring an improved fish product with the high omega-3 fatty acids content. This in fact produces high quality omega-3 fatty acids enriched fish than wild caught fish.
5. As no prior arts disclose enriched fruit peel wastes with omega-3 fatty acids producing thraustochytrids, the present invention is distinguished as unique, highly sustainable, and zero-waste material in the field of aquaculture.
6. The uniqueness of the present invention is that the process is designed in a manner to establish the said feed production units in small-scale level which provides more viability, sustainability, profit and direct benefit to farmers and entrepreneurs.

1. A fruit peel wastes-based composite as a feed product for aquaculture farms and industries comprising:
a. Total Lipid Content—20% to 30%,
b. Microbial Lipid Content—8% to 10%,
c. Carbohydrates—2.6% to 4.2%,
d. Crude Fibre—6.0% to 7.0%,
e. Phosphorus—0.10% to 0.22%,
f. Protein Content—30% to 40%,
g. Ash content—14.5% to 16.5%, and
h. Ascorbic Acid Content—0.10% to 0.12%.

2. The composite as claimed in claim 1, wherein the composite is prepared from fruit peels selected from the group consisting of pineapple, banana, orange and mausambi in the ratio of 0.8 to 1.5:1.5 to 2.10:2 to 3:1.10 to 1.40 along with 20% Aurantiochytrium seed cells.

3. The composition as claimed in claim 1, wherein the composite is prepared by a method comprising:
i) obtaining pineapple, banana, orange and mausambi peels,
ii) drying the peels obtained in (i) in a temperature range of 25° C. to 30° C. and powdering it to obtain peels powders,
iii) mixing the peels powders obtained in (ii) in the ratio 0.8 to 1.5:1.5 to 2.10:2 to 3:1.10 to 1.40 in a temperature range of 25° C. to 30° C. to form a composite, and sterilization of the composite,
iv) lipid enrichment of the composite obtained in (iii) with Aurantiochytrium by fermentation at 20° C.-30° C. to obtain a fermented composite, and
v) mixing the fermented composite obtained in (iv) with soyabean and soyabean husk to adjust the total protein concentration of the fermented composite in the range of 30% to 50%.

4. The composite as claimed in claim 1, wherein the composite is pelleted in the size range of 1.00 mm to 3.00 mm.

5. Use of the composite as claimed in claim 1 as a fish feed.
